(19) United States
(12) Patent Application Publication
(10) Pub. No.: US 2016/0059238 A1
(43) Pub. Date: Mar. 3, 2016

(54) ROLL TYPE CRUSHER WITH SYNCHRONIZED DRIVE TRAIN

(71) Applicant: TAKRAF GmbH, Leipzig (DE)

(72) Inventors: Bruno GÖTZ, Wiehl (DE); Thomas STENZEL, Hohenleipisch (DE)

(21) Appl. No.: 14/834,777

(22) Filed: Aug. 25, 2015

(30) Foreign Application Priority Data
Aug. 26, 2014 (DE) 10 2014 216 963.1

(51) Int. Cl. B02C 4/42; B02C 4/02; F16H 37/04

(52) U.S. Cl. CPC B02C 4/42; F16H 37/04; B02C 4/02

(57) ABSTRACT

A roll crusher has at least two crushing rolls and at least two drive trains for the driving of the crushing rolls. The drive trains have each at least one gear for the reduction of the motor speed and a corresponding increase of the torque. The synchronization takes place on a faster-running side of the gear, i.e., the side with lower torque, such that advantageously markedly lower torques are transmitted. The synchronization may be markedly more compact and thus more cost-effective, since markedly lower torques have to be transmitted. The synchronization may have a variety of designs including a simple connection of input shafts of the gears to one another to synchronize them with a corresponding arrangement. The synchronization may thus advantageously be designed for markedly lower torques and thus be markedly more compact in dimensions and be dimensioned more cost-effectively.

### CROSS REFERENCE TO RELATED APPLICATIONS

This application claims the benefit of priority under 35 U.S.C. §119 of German Patent Application 10 2014 216 963.1 filed Aug. 26, 2014, the entire contents of which are incorporated herein by reference.

### FIELD OF THE INVENTION

The present invention pertains to a roll type crusher (roll crushers) having at least two crushing rolls and having at least two drive trains with at least one gear each.

### BACKGROUND OF THE INVENTION

A variety of roll type crushers are known from the state of the art, and the present invention pertains to crushers having at least two synchronized crushing rolls. Various possibilities are known for the synchronization of the rolls. The synchronization frequently takes place on the non-driven side of the crushing rolls via gear wheels. In other embodiments, the synchronization of the crushing rolls is frequently carried out on the driven side via a synchronization step after the gear reduction in front of the crushing roll. As a drawback, because of the high acting torques, the synchronization has to be designed correspondingly, with negative consequences on size and manufacturing costs.

For example, a crusher, which has two drive shafts that are synchronized on the slow-running gear side, is presented in DE 10 2011 106 123 A1. As a drawback, a mechanically very stable and thus cost-intensive design of the synchronization step is necessary

### SUMMARY OF THE INVENTION

The object of the present invention is to provide a roll type crusher (a roll crusher), which has a synchronization of the crushing rolls that is cost-effective to manufacture and has a small size.

The roll type crusher according to the present invention has at least two crushing rolls and at least two drive trains for the driving of the crushing rolls. The drive trains have at least one gear (e.g., a gear with a plurality of gear stages—a gear arrangement) each for the reduction of the motor speed and corresponding increase of the torque. According to the present invention, the synchronization takes place on the fast-running side of the gear, i.e., the side with lower torque, such that advantageously markedly lower torques have to be transmitted. In other words, the synchronization of the drive trains takes place with a synchronization arrangement on the input side of the gear or on the motor side. Thus, the design of the synchronization can prove to be markedly smaller and thus more cost-effective, since markedly lower torques have to be transmitted.

The synchronization (arrangement) may have a variety of designs. One possibility is to simply connect the input shafts of the gears and thus to synchronize them (for example, by means of a pair of gear wheels) with corresponding arrangement. The synchronization can thus be designed for markedly lower torques and thus be markedly smaller in dimensions and thus also be dimensioned more cost-effectively.

The synchronization (arraignment) may also take place outside of the gears before the speed reduction. For this, the widest variety of possibilities is conceivable, for example, this may be by means of an additional bevel gear stage with a compact design at each drive train, which are likewise coupled to one another in a torsion-proof manner. A universal joint shaft, which acts on the input stage of the gears, but which is preferably coupled into the gear, may also be provided.

The coupling into the drive train may vary markedly depending on the gears and motors used and their arrangement. A connection of the output shafts of the motors via a synchronization shaft is possible, for example. The synchronization shaft is preferably designed as a universal joint shaft in order to compensate shifts in the position of the motors or gears. As an alternative, the synchronization may also be coupled via the gears, for example, onto the input shafts of the gears.

The synchronization of the fast-running gear stage preferably has a coupling, preferably a curved teeth coupling, which may advantageously compensate low offset under high load. The coupling is preferably designed here as a safety coupling, which is automatically released beginning from a specific triggering torque.

Two exemplary embodiments of the present invention are explained below on the basis of figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic diagram of the synchronization according to the present invention;

FIG. 2 is a schematic diagram of a first exemplary embodiment with coupling of the synchronization into the drive shaft of the motors; and

FIG. 3 is a schematic diagram of a second exemplary embodiment with coupling of the synchronization into the input shaft of the gears.

### DESCRIPTION OF THE PREFERRED EMBODIMENTS

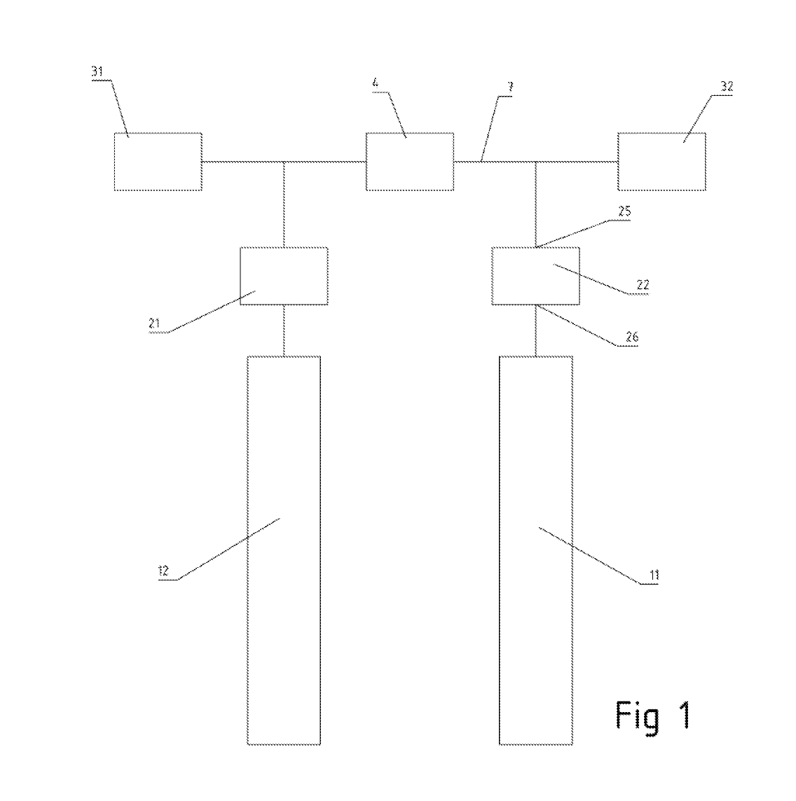

Referring to the drawings, FIG. 1 shows a schematic diagram of a roll type crusher with two crushing rolls 11 and 12 with synchronization according to the present invention. The two motors 31 and 32 drive two crushing rolls 11 and 12 via two gears 21 and 22. The two drive trains are synchronized via a synchronization shaft 7 before coupling into the respective gear 21 and 22. The gears 21 and 22 have a gear side with low torque 25 facing the motor and a gear side with high torque 26 facing the crushing roll 11, 12. Correspondingly, the gear side with low torque 25 has a higher speed and the gear side with the higher torque 26 has a lower speed. The synchronization shaft 7 has, in addition, a coupling 4. The motors 31 and 32 are electric motors. The coupling 4 may additionally be designed as a safety coupling and the coupling 4 separates the transmission of force with a blocking of one drive train for the protection of the system.

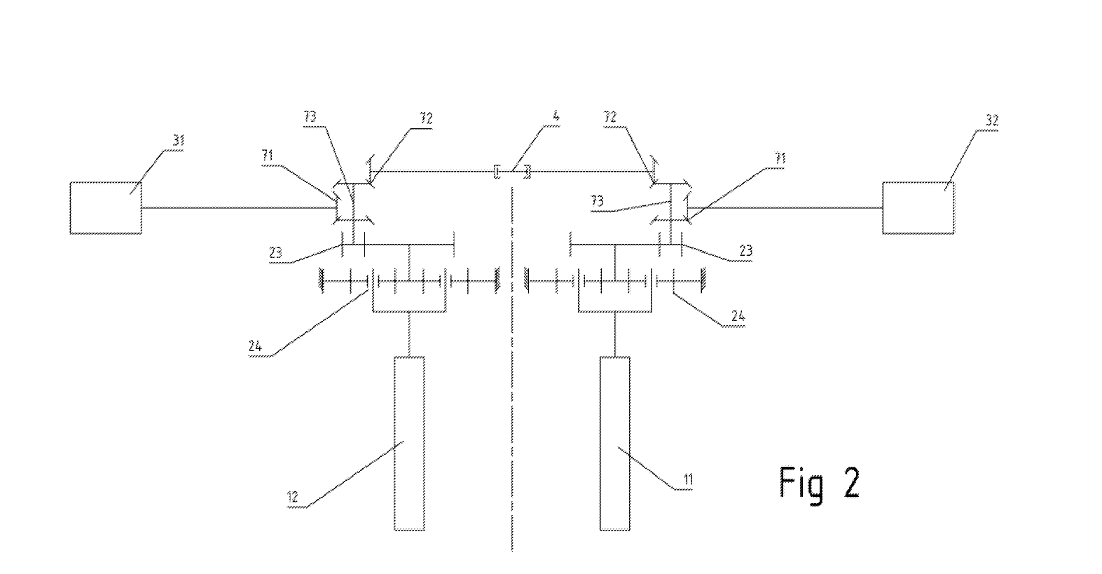

FIG. 2 shows a schematic diagram of a variant of the coupling of the synchronization into the drive train. The gears 21 and 22 are divided into a first stage in the form of a spur gear pair 23 and a second stage in the form of a planet gear 24. The motor shaft motion is transmitted in this case to a gear input shaft 73 via a bevel gear pair 71. The coupling of the synchronization shaft 7 onto the gear input shaft 73 likewise takes place via a bevel gear pair 72.

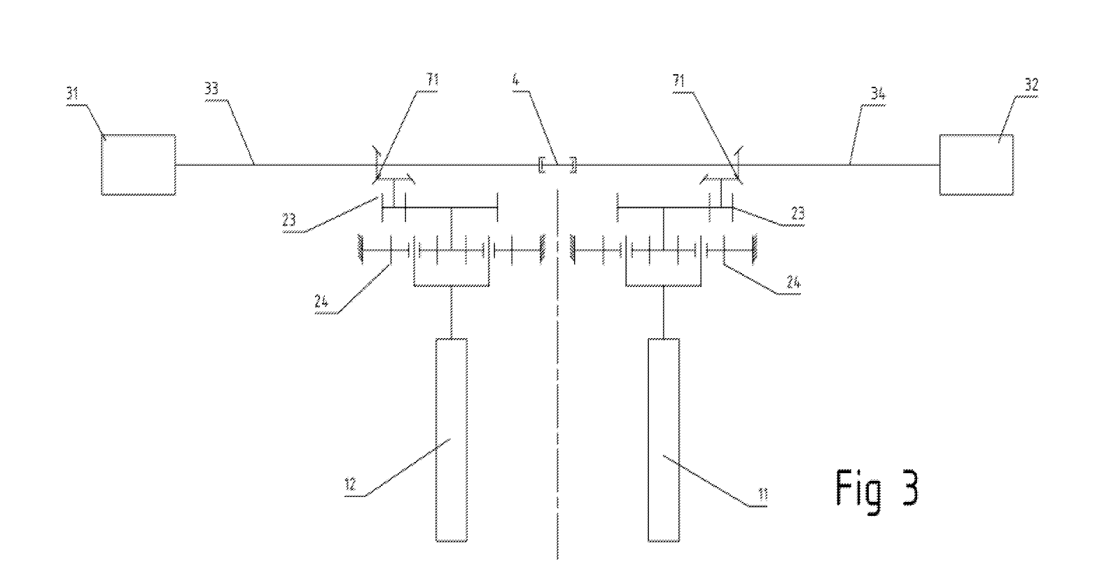

FIG. 3 shows a further variant of the coupling. The output shafts 33 and 34 of the motors 31 and 32 are connected in this case by means of the synchronization shaft 7. The drive train is connected to the gears 21 and 22 via bevel gear pairs 71.

While specific embodiments of the invention have been shown and described in detail to illustrate the application of the principles of the invention, it will be understood that the invention may be embodied otherwise without departing from such principles.

### APPENDIX

List of Reference Numbers

| | |
|---|---|
| 11 | Crushing roll |
| 12 | Crushing roll |
| 21 | Gear 1 |
| 22 | Gear 2 |
| 23 | Spur gear pair |
| 24 | Planet gear |
| 25 | Gear-side low torque |
| 26 | Gear-side high torque |
| 31 | Motor 1 |
| 32 | Motor 2 |
| 33 | Output shaft of motor 1 |
| 34 | Output shaft of motor 2 |
| 4 | Coupling |
| 7 | Synchronization shaft |
| 71 | Bevel gear pair |
| 72 | Bevel gear pair |
| 73 | Gear input shaft |

What is claimed is:

1. A roll crusher comprising:
at least two crushing rolls;
at least two drive trains, each drive train comprising at least one gear operatively connected to a motor for a reduction of a motor speed; and
a synchronization arrangement connected to each of the drive trains with synchronization of the drive trains on a gear side with lower torque.

2. A roll crusher in accordance with claim 1, wherein the synchronization takes place via gear wheels on the gear input side.

3. A roll crusher in accordance with claim 1, wherein the synchronization takes place by means of a connection of motor output shafts.

4. A roll crusher in accordance with claim 3, wherein the synchronization arrangement comprises a coupling.

5. A roll crusher in accordance with claim 3, wherein the synchronization arrangement comprises a curved teeth coupling.

6. A roll crusher in accordance with claim 5, wherein the synchronization arrangement comprises a synchronization shaft comprising a universal joint shaft.

7. A roll crusher comprising:
a first motor;
a second motor;
a first crushing roll;
a second crushing roll;
a first drive train comprising a first drive train gear arrangement with a first drive train input side operatively connected to the first motor, the first drive train providing a reduction of a first motor speed and a corresponding increase of first motor torque at a first drive train output side;
a second drive train comprising a second drive train gear arrangement with a second drive train input side operatively connected to the second motor, the second drive train providing a reduction of a second motor speed and a corresponding increase of second motor torque at a second drive train output side; and
a synchronization arrangement connected to the first drive train input side with a first motor side fast-running speed and lower torque and connected to the second drive train input side with a second motor side fast-running speed and lower torque.

8. A roll crusher in accordance with claim 7, wherein the synchronization arrangement comprises gear wheels on the gear input side.

9. A roll crusher in accordance with claim 7, wherein the synchronization arrangement comprises a connection of motor output shafts.

10. A roll crusher in accordance with claim 9, wherein the synchronization arrangement comprises a coupling.

11. A roll crusher in accordance with claim 9, wherein the synchronization arrangement comprises a curved teeth coupling.

12. A roll crusher in accordance with claim 7, wherein the synchronization arrangement comprises a synchronization shaft comprising a universal joint shaft.
